(19) United States
(12) Patent Application Publication
(10) Pub. No.: US 2019/0358582 A1
(43) Pub. Date: Nov. 28, 2019

(54) SYSTEM AND PROCESS FOR SEPARATING GAS COMPONENTS USING MEMBRANE FILTRATION TECHNOLOGY

(71) Applicant: James Khreibani, Miami, FL (US)

(72) Inventor: James Khreibani, Miami, FL (US)

(21) Appl. No.: 16/421,421

(22) Filed: May 23, 2019

Related U.S. Application Data
(63) Continuation of application No. 62/675,722, filed on May 23, 2018, now abandoned.

(51) Int. Cl. B01D 53/22; B01D 53/00; C10L 3/10; F25J 3/08

(52) U.S. Cl. CPC B01D 53/229; B01D 53/002; C10L 3/101; F25J 3/08; B01D 2256/245; B01D 2257/302; F25J 2205/80; B01D 2257/504; B01D 2257/80; B01D 2257/7022; F25J 2205/04; F25J 2205/30; F25J 2205/50; B01D 2257/304

(57) ABSTRACT

This disclosure relates to a means of separating a gaseous mixture into both a purified stream and reject stream that can each be used for individual purposes. The disclosure will generally be connected to a gas supply such as a wellhead or gas pipe or other source where the gas makes contact with a membrane filter. The gaseous mixture should either have sufficient intrinsic pressure to be optimally filtered by the membrane filter or have the pressure boosted. Means of increasing the pressure includes ejectors, vacuum pumps and where the gas composition allows compressors. The retentave may be discharged into a pipeline, road or rail carriage or be liquefied. The permeate may be combusted through a combustion device to generate electricity and heat. Alternatively, the permeate may be discharged into a pipeline, road or rail carriage or stored for further use. The advantages of this disclosure include reduced capital and operational cost and a reduction in unnecessary environmental emissions.

### CROSS-REFERENCE TO RELATED APPLICATIONS

This application claims the benefit of provisional patent application Ser. No. 62/675,722, filed 2018 May 23 by the present inventor.

### FIELD OF THE INVENTION

This disclosure relates to a means of separating a gaseous mixture into both a purified stream and a reject stream that can each be used for individual purposes. This disclosure by way of example and not limitation will generally be connected to a gas supply including but not limited to a wellhead, gas pipe or other application.

### BACKGROUND OF THE INVENTION

The following is a tabulation of related art that presently appears relevant:

U.S. Patents

| Pat. No. | Kind Code | Issue Date | Patentee |
|---|---|---|---|
| Pat. No. 4,386,944 | A | 1983 Jun. 7 | Kimura |
| Pat. No. 9,649,591 | B2 | 2017 May 16 | Lien |
| Pat. No. 5,753,008 | A | 1998 May 19 | Friesen |
| Pat. No. 6,035,641 | A | 2000 Mar. 14 | Lokhandwala |

Foreign Patent Documents

| Patent Number | Country Code | Kind Code | Issue Date | Patentee |
|---|---|---|---|---|
| 1,372,822 | EP | B1 | 2006 May 31 | Schucker |

Nonpatent Literature Documents

| Title | Issue Date | Author |
|---|---|---|
| Membranes for Vapor/Gas Separation | 2006 | Baker |
| GGFR Technology Overview—Utilization of | 2018 July | World Bank |
| Small-Scale Associated Gas | | |
| Recent Advances on Membrane-Based Gas | 2018 August | Xu |
| Separation Processes for CO₂ Separation | | |

It is well known in the art that the most common means of processing Natural Gas (NG) and Bio-Gas (BG) is for the gas to be extracted from a well at the wellhead and diverted through gathering pipelines to a collection point where the impurities are then removed to meet specific compositional specifications. It is also well known in the art that the most common method of processing methane (CH₄) from a gas stream generated from NG or BG is by using a chemical treatment plant (for example and without limitation an amine plant). This requires complex chemicals, steam, high electrical consumption and associated mechanical equipment each with significant capital, operational and transportation costs. Chemical treatment plants are generally large permeant structures and therefore not suitable for installation at small-scale gas production operations. The inability to process gas locally to the production source (for example and without limitation a wellhead) significantly contributes to the routine flaring of environmentally harmful gas and installation of expensive gathering pipelines.

Kimura within U.S. Pat. No. 4,386,944 disclosed an ejector and membrane filter design philosophy which incorporates a gas-motive ejector installed on the permeate side of a membrane filter. To generate the motive gas required to drive the ejector, a closed loop steam system incorporating a boiler is installed. Water is heated in the boiler to generate steam which passes through the ejector at a higher pressure than the impure gas stream, therefore increasing the overall ejector discharge pressure through the Venturi effect. The impure gas is separated from the steam by condensing the steam back into water before returning the condensed water back to the boiler and the cycle repeated. However this disclosure has inherent reliability issues which include but not limited to, boiler tube leaks, boiler water production losses, sour gas corrosion, and other issues. It also has cost disadvantages through the need to install and operate boilers, maintenance costs and uninterrupted supply of boiler combustion product.

Lien within U.S. Pat. No. 9,649,591 disclosed a membrane filter design philosophy where an impure gas supplied at suitable pressure is passed through a membrane filter where the desired gas component is discharged as retentate and the impure gas components are rejected through the permeate stream. The permeate stream is then collected within a container for further use. The disclosure has inherent complications in that the stored permeate remains impure by way of example and without limitation natural gas liquids (NGL), CO₂, H₂S and other impurities. Therefore the stored permeate requires further offsite processing prior to commercialization. Additional issues with the disclosure are apparent when the permeate storage container is filled to maximum capacity forcing the operation to stop as the art provides no further solution. To remove the permeate offsite to prevent container overfill requires expensive gathering pipelines suitable to transport the specific captured gasses and components. Alternatively, specialist road trailers will require specified permeate purity requirements to be met which will come at further additional cost.

There exists a need in art detailed by Friesen within U.S. Pat. No. 5,753,008 and Schucker within EP 1,372,822 to modify and improve the disclosed membrane filter system design. Both related art references use vaper permeation or membrane pervaporation to separate pure gas from impure components. A vacuum and condenser are used to produce the required pressure on the permeate side of the membrane. However the disclosure has inherent reliability issues which include but not limited to, heat exchanger tube leaks, boiler water production losses, cooling product supply, sour gas corrosion and other issues. It also has cost disadvantages associated with installation, operation and maintenance of heat exchangers and supply of constant cooling medium.

The art disclosed by Lokhandwala showed a process involving the separation of natural gas and nitrogen using membrane filtration. The permeate stream containing CH₄ is separated from the retentive stream which contains the nitrogen (N) and remaining gas impurities for further use. The CH₄ enriched permeate stream is routed to a turbine where it is combusted to generate electricity. Natural gas direct from the well contains an approximate CH₄ content between 60% to 90% making it the single largest gaseous component. This disclosure requires combustion of the CH₄ permeate stream which is equivalent to the majority of the gas stream from the well. CH₄ is the most commercially in demand component within the gas stream and therefore has the largest gathering and transmission pipeline to facilitate commercialization. The nitrogen retentive components may contain other impurities including CO₂ and H₂S reducing the commercial value. To extract retained natural gas liquids (NGL) within the retentave requires additional chillers and heaters, further its limiting economical use without suitable and expensive gathering pipelines to transport to the collection point for further processing. Simply put the disclosure combusts the most valuable component, CH₄, and retains the least valuable components for further use. Should the production operation utilizing the permeate gas supply not require the amount of electricity generated by the total CH₄ component then unused electricity or unnecessary flaring of excess gas creating additional environmental emissions will occur.

Baker discussed within Membranes for Vapor/Gas Separation (2006) a number of methods using membrane filters to separate vapor and inert gas at a process facility or a gas terminal and not specifically a wellhead. However these methods use reactors, heated separators and condensers to function. The disclosure has inherent reliability issues which include but not limited to heat exchanger tube leaks, boiler makeup water production losses, cooling medium supply, sour gas corrosion and other issues. It also has cost disadvantages including a need to install and operate heat exchangers, maintenance costs, supply constant power and supply of cooling medium. Baker also discussed a method of diverting gas already contained within a natural gas pipeline. The diverted gas travels through a membrane filter before the retentave (purified gas) is combusted through a gas engine which is then used to power the existing gas transmission pipeline compressor already pressurizing the natural gas pipeline. However the art does not process gas before entering a natural gas pipeline, therefore the gas still needs re-processing at the collection point prior to further use. The permeate reject stream is returned back to the original natural gas pipeline increasing the percentage of total impurities within the gas pipeline whereby future processing costs to remove the impurities will increase.

The World Bank discussed within GGFR Technology Overview—Utilization of Small-Scale Associated Gas (2018) a membrane filtration system which requires the gas to be cooled through chiller units and the permeate steam stored for further use. Issues relating to the art include reliability, installation and operational costs associated with the chiller unit and the same storage and transportation issues previously discussed within Lien's disclosure (U.S. Pat. No. 9,649,591), above.

The World Bank also discussed the latest developments in small-scale gas reciprocating engines and gas turbines that are capable of combusting both natural gas and byproducts such as natural gas liquids (NGL) with additional high impurity percentages which may include but not limited to CO₂ and H₂S. However, the art has no ability to selectively separate specific gas components before combustion limiting the flexibility to combust reject gas products and retain specific gas products for future use. As with the disclosure made by Lokhandwala, production operations utilizing the filters gas supply may not require the amount of electricity generated by combusting the total gas supply from the wellhead, resulting in excess electricity or unnecessary flaring of excess gas creating additional environmental emissions.

Another reference made by the World Bank relates to small-scale liquefied natural gas (LNG) technologies for use when a pipeline may be uneconomical or not yet constructed. The process to create LNG or liquefied bio-gas (LBG) is well known and for example without limitation may use the reverse turbo-Brayton principles to cool the gas to the condensation temperature to create gas liquid phase change. Generally the CH₄ gas liquid phase change requires a temperature of −160 degrees Celsius. To reach the desired gas liquid phase change temperature requires impurities to be sufficiently removed for example and without limitation, H₂O, to prevent freezing and equipment damage. However, all known small-scale LNG or LBG technologies use adsorption and/or absorption pre-treatment techniques (e.g. PTSA, reactors or glycol dehydration) to remove impurities in the gas stream prior to liquefaction. Using adsorption and/or absorption techniques has inherent reliability issues which include byway of example and not limitation heat exchanger leaks, onsite makeup water production losses, loss of cooling medium, sour gas corrosion, loss of chemicals and associated chemical corrosion. The disclosure also has cost disadvantages associated with installing and operating the adsorption and/or absorption plant, maintenance costs, supplying constant cooling medium and replenishing expensive chemicals. This publication was also issued after this disclosures related application was made.

Xu records within Recent Advances on Membrane-Based Gas Separation processes for CO₂ separation (2018) the advantages and disadvantages of various gas processing methods including adsorption, absorption and membrane technology. No detail is provided on how to utilize the permeate reject gas stream. This publication was also issued after this disclosures related application was made.

### BRIEF SUMMARY OF THE INVENTION

Generally stated the disclosure provides a means of separating a gaseous mixture byway of example and not limitation natural gas which contains a desired gas component (e.g. CH₄) from other impurities (e.g. C₂H₆). This disclosure provides a means of processing and separating a gaseous mixture local to the source (e.g. wellhead) by incorporating pressure and membrane filtration technology. The advantage of this disclosure when compared to related art provides means of substantial utilization of both the desired gas components and impurities e.g. Natural Gas Liquid (NGL). The disclosure requires no additional chemicals, heating or cooling plant and its modular design allows a plurality of components to be combined in both parallel and series as required to meet both small and large scale production operations and varying gas compositions.

### BRIEF DESCRIPTION OF THE DRAWINGS

The various embodiments of this disclosure will be better understood by referring to the following detailed description and the accompanying drawings which illustrate the disclosed configurations.

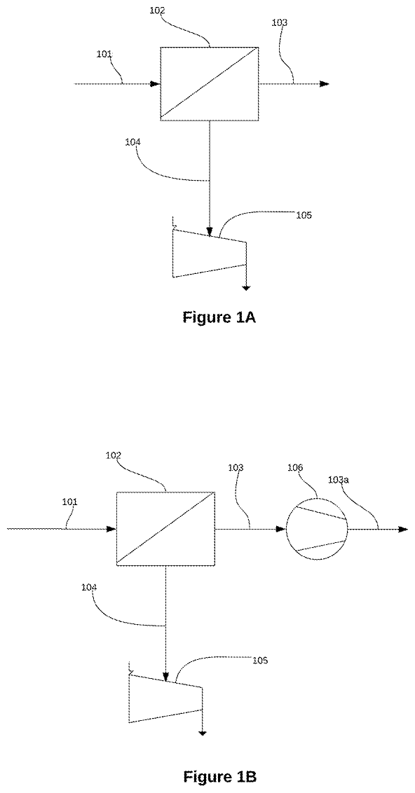

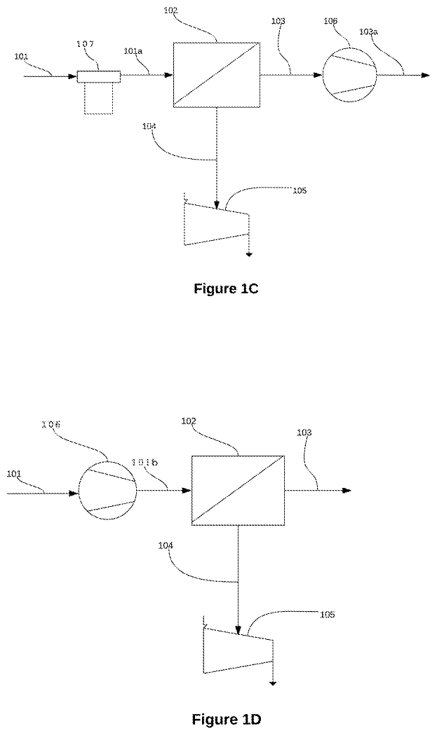

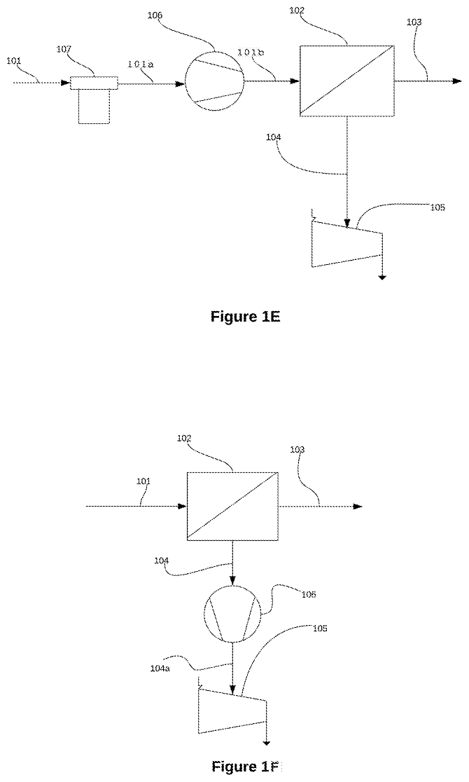

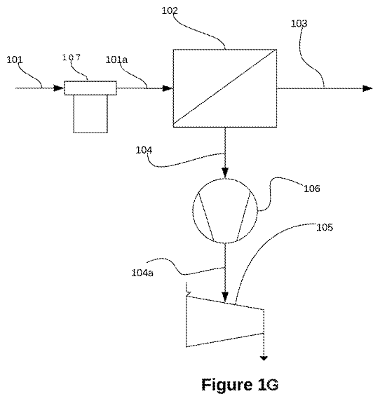

FIG. 1A to 1G show flow diagrams schematically illustrating the use of a rotational compression device and membrane filter in various arrangements to produce gas suitable for pipeline, carriage and liquefaction. The reference numerals represent the following:
101 gaseous mixture
101a gas liquid solid phase separating device gas discharge
101b rotational compression device discharge
102 membrane filter
103 membrane filter retentave discharge (purified gas)
103a rotational compression device retentave discharge
104 membrane filter permeate discharge (reject product)
104a rotational compression device permeate discharge
105 combustion device
106 rotational compression device
107 gas liquid solid phase separating device

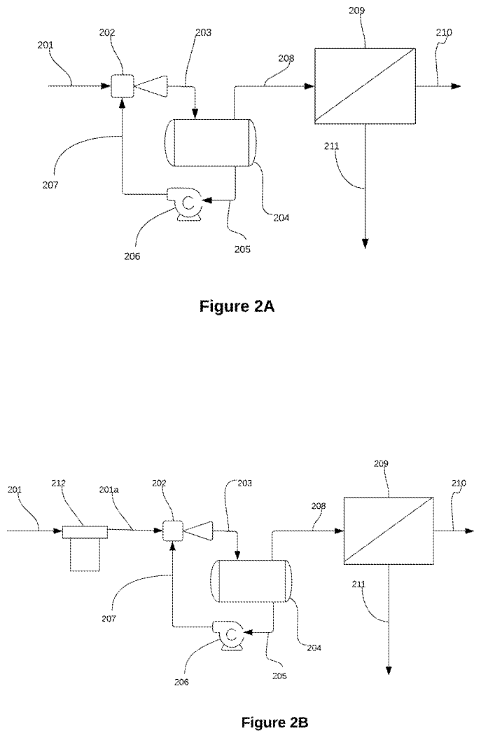

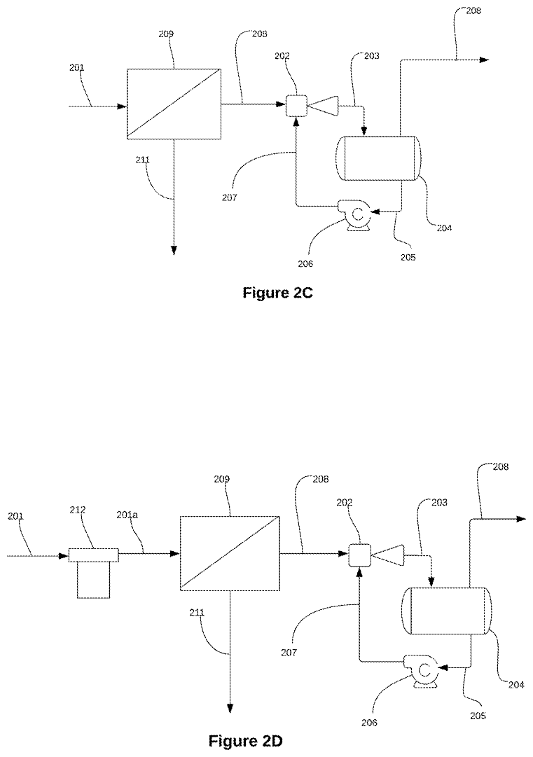

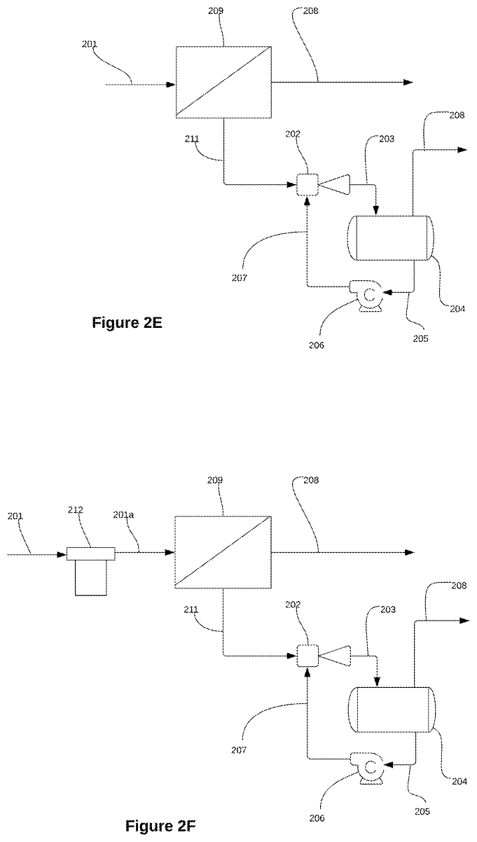

FIG. 2A to 2F show flow diagram schematically illustrating the use of a liquid-motive ejector device and membrane filter in various arrangements to produce gas suitable for pipeline, carriage and liquefaction. The reference numerals represent the following:
201 gaseous mixture
201a gas liquid solid phase separating device discharge
202 ejector or inductor
203 gas liquid mixture ejector discharge
204 drum
205 drum liquid motive discharge
206 compression device
207 compression device liquid motive discharge
208 drum gas discharge
209 membrane filter
210 membrane filter retentave discharge (purified gas).
211 membrane filter permeate discharge (reject product).
212 gas liquid solid phase separating device

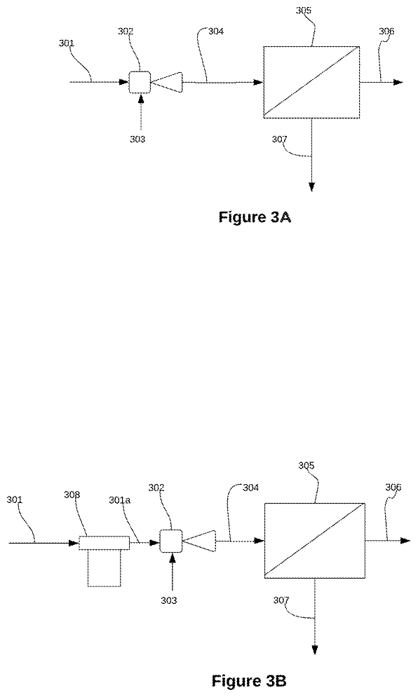

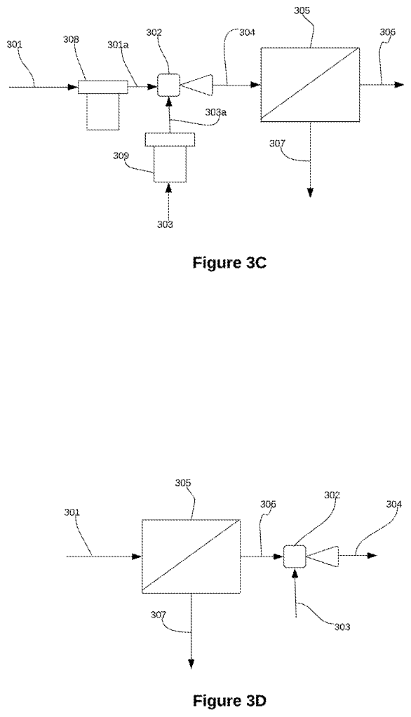

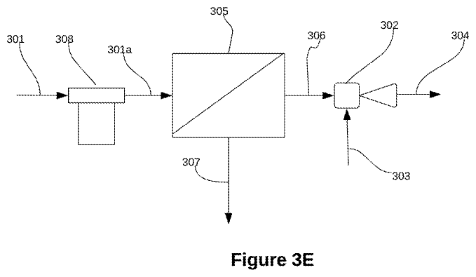

FIG. 3A to 3E shows a flow diagram schematically illustrating the use of a gas-motive ejector device and membrane filter to produce gas suitable for pipeline, carriage and liquefaction. The reference numerals represent the following:
301 gaseous mixture
301a gas liquid solid phase separating device discharge
302 ejector or inductor
303 high pressure gas motive
303a high pressure gas liquid solid phase separating device discharge
304 ejector discharge
305 membrane filter
306 membrane filter retentave discharge (purified gas).
307 membrane filter permeate discharge (reject product).
308 gas liquid solid phase separating device
309 high pressure gas liquid solid phase separating device

### DETAILED DESCRIPTION OF THE INVENTION

Generally stated Natural Gas (NG) and Bio-Gas (BG) is presently extracted from a well at the wellhead and diverted through gathering pipelines to a collection point where the impurities are removed to specific standards using a chemical treatment plant. The purified processed gas is then transported through transmission and distribution pipelines to the final user. Gathering pipelines are often expensive and time consuming to install as the gas may travel many miles to the designated collection point. Gas from the well may have high sulfur (H₂S) and carbon dioxide (CO₂) which is often termed sour gas and corrosive in nature. Therefore sour gas transportation from the wellhead to the processing plant must be done carefully which requires significant routine monitoring and inspections further increasing the operational cost of the gathering pipeline. Gas from the well may also contain significant Natural Gas Liquids (NGL) which are also separated at the processing plant.

This disclosure generally relates to a means of separating a gaseous mixture into both a purified stream and reject stream that can each be used for individual purposes. This disclosure will generally be connected to a gas supply including but not limited to a wellhead, gas pipe or other application. More specifically one embodiment of this disclosure is shown in FIG. 1A whereby a gaseous mixture (101) of sufficient intrinsic pressure becomes in contact with a membrane filter (102) or plurality of membrane filters (102) whereby it is separated to form both retentive and permeate gaseous steams. Gas separation by means of using membranes is known and is covered in many previous patents. The membrane filter retentive gaseous mixture (103) is relatively rich in the pure gaseous component and relatively lean in the additional impure component. The membrane filter permeate discharge (104) reject stream is comprised of gaseous mixture relatively lean in said pure gaseous component and relatively rich in said additional impure gaseous components. It should be noted that the permeate component (104) may also contain some liquids. The Membrane Filter (102) allows the impurities within the gaseous mixture (101) to pass through a semipermeable barrier under the intrinsic pressure within the gaseous mixture (101) and the differential pressure at the opposite side of the semipermeable barrier. The impurities which may include, but not limited to H₂O, CO₂, H₂S, C₂H₆, C₂H₈ and others are rejected from the process through the membrane permeate stream (104). The membrane filter retentive (103) is then discharged for example but not limited into a pipeline (not shown), road or rail carriage (not shown), or small-scale liquefaction unit (not shown). The liquefaction unit cools the retentate (103) to a suitable condensation temperature to create a gas liquid phase change. The membrane filter permeate (104) makes contact with a combustion device (105) which may include but not limited to a NGL fueled micro-turbine or reciprocating engine generating power and heat as required. The generated power and heat may be used to support associated field activities or sold back into the grid for other uses. An increase in the calorific value of the membrane filter permeate discharge (104) maybe required to optimize combustion in the combustion device (105). A percentage of the membrane filter retentave discharge (103) can be drawn off and mixed with the membrane filter permeate discharge (104) to increase the combined calorific value at the combustion device (105) inlet and optimize combustion efficiency.

In another embodiment of the disclosure and referring to FIG. 1C a gas liquid solid phase separating device (107), for example but not limited to a coalescing filter, is located upstream of the membrane filter (102) to remove liquid and solid substances, for example but not limited to water and sand, from the pressurized gaseous mixture (101). The gas liquid solid phase separating device gas discharge (101a) then becomes in contact with the membrane filter (102). The subsequent steps detailed in FIG. 1A are then repeated.

FIG. 1B shows another embodiment of the disclosure where the gaseous mixture (101) requires additional pressure for optimal separation through the membrane filter (102). To increase the pressure, a rotational compression device (106), for example but not limited to a gas compressor or vacuum pump, is installed downstream of the membrane filter retentave discharge (103). The rotational compression device (106) draws the retentave discharge (103) from the membrane filter (102). The membrane filter (102) then draws the gas mixture (101) from the well. The rotational compression device (106) then discharges the rotational compression device retentave discharge (103a) into a pipeline (not shown), road or rail carriage (not shown), or small-scale liquefaction unit (not shown).

FIG. 1C shows another embodiment of the disclosure whereby a gas liquid solid phase separating device (107), for example but not limited to a coalescing filter, is placed upstream of the membrane filter (102) to remove liquid and solid substances from the gaseous mixture (101) before the gas liquid solid phase separating device gas discharge (101a) becomes in contact with the membrane filter (102) where the subsequent steps described in previous embodiments is repeated.

FIG. 1D shows another embodiment of the disclosure whereby the gaseous mixture (101) low in corrosive properties is pressurized by a rotational compression device (106) located upstream of the membrane filter (102). The rotational compression device discharge (101b) then contacts the membrane filter (102) where the subsequent steps described in previous embodiments is repeated.

FIG. 1E shows another embodiment of the disclosure whereby a gas liquid solid phase separating device (107) is placed upstream of the rotational compression device (106) to remove liquid and solid substances from the gaseous mixture (101). The gas liquid solid phase separating device gas discharge (101a) becomes in contact with the rotational compression device (106) where the gas is pressurized. The rotational compression device discharge (101b) then becomes in contact with the membrane filter (102) where the subsequent steps described in previous embodiments is repeated.

FIG. 1F shows another embodiment of the disclosure where the gaseous mixture (101) requires additional pressure for optimal separation through the membrane filter (102). To increase the pressure, a rotational compression device, for example but not limited to a gas compressor or vacuum pump (106), is installed downstream of the membrane filter permeate discharge (104). The rotational compression device (106) draws the permeate discharge (104) from the membrane filter (102). The membrane filter (102) then draws the gas mixture (101) from the well. The rotational compression device (106) then discharges the rotational compression device permeate discharge (104a) into a combustion device (105). The membrane retentave (103) is then discharged to a pipeline (not shown), road or rail carriage (not shown), or small-scale liquefaction unit (not shown).

FIG. 1G shows another embodiment of the disclosure whereby the gaseous mixture (101) comes into contact with a gas liquid solid phase separating device (107) where liquid and solid substances are removed from the gaseous mixture. The gas liquid solid phase separating device gas discharge (101a) then enters the membrane filter (102) where the subsequent steps described in FIG. 1F are repeated.

FIG. 2A shows another embodiment of the disclosure where a gaseous mixture (201) passes through an ejector (202) which increases pressure within the gas liquid mixture ejector discharge (203) to the optimal pressure for the membrane filter (209). The gas liquid mixture ejector discharge (203) enters the drum (204) where it is substantially separated into gas and liquid phases through means of pressure and gravity within the drum (204). The drum gas discharge (208) exits the drum (204) and the liquid is substantially retained within the drum (204). The compression device (206) which includes but not limited to a circulating pump draws drum liquid motive discharge (205) from the drum (204). The compression device (206) produces pressure within the compression device liquid motive discharge (207) which provides motive liquid pressure to drive the ejector (202). The ejector (202) mixes the relatively high pressure compression device liquid motive discharge (207) with the relatively low pressure gaseous mixture (201) resulting in an intermediate pressure gas liquid mixture ejector discharge (203) and substantially creates a closed loop retaining the liquid motive within the system. The drum gas discharge (208) makes contact with the membrane filter (209) at the optimum pressure. The membrane filter retentave discharge (210) is then discharged to, for example but not limited to, a pipeline (not shown), road or rail carriage (not shown), or small-scale liquefaction unit (not shown). The membrane filter permeate (211) may be discharged into a pipeline (not shown), storage container (not shown) or combustion device (not shown) which may include but not limited to a micro-turbine or reciprocating engine generating power and heat as required. The generated power and heat from the combustion device may be used to support associated field activities or sold back into the grid for other uses. Should an increase in the calorific value of the membrane filter permeate discharge (211) be required to optimize combustion in the combustion device then a percentage of the membrane filter retentave discharge (210) can be drawn off and mixed with the membrane filter permeate discharge (211) to increase the combined calorific value at the combustion device inlet and optimize combustion efficiency. In other embodiments of the disclosure the gas liquid mixture ejector discharge (203) is separated in a drum (204) with external heat control or additional gas liquid separator.

FIG. 2B shows another embodiment of the disclosure whereby a gas liquid solid phase separating device (212) for example but not limited to a coalescing filter is placed upstream of the membrane filter (202) to remove liquid and solid substances from the gaseous mixture (201) before the gas liquid solid phase separating device gas discharge (201a) becomes in contact with the ejector (202) where the subsequent steps described in FIG. 2A are repeated.

FIG. 2C shows another embodiment of the disclosure where the gaseous mixture (201) comes into contact with the membrane filter (209). The membrane filter separates the gaseous mixture (201) into membrane filter retentave discharge (210) and membrane filter permeate discharge (211) which may be discharged into a pipeline (not shown), storage container (not shown) or combustion device (not shown) or other use. Should a combustion device be used, the generated power and heat may support associated field activities or sold back into the electrical grid. Should an increase in the calorific value of the membrane filter permeate discharge (211) be required to optimize combustion in the combustion device then a percentage of the membrane filter retentave discharge (210) can be drawn off and mixed with the membrane filter permeate discharge (211) to increase the combined calorific value at the combustion device inlet and optimize combustion efficiency. To draw the gaseous mixture (201) through the membrane filter (209) at optimal pressure the membrane retentive (210) enters the ejector (202) where the same closed loop liquid motive circuit detailed in FIG. 2A involving a drum (204) and compression device (206) provides the compression device liquid motive discharge (207) used to drive the ejector (202). The drum gas discharge (208) which is separated from the gas liquid mixture ejector discharge (203) in the drum (204) is then discharged into a pipeline (not shown), road or rail carriage (not shown), or small-scale liquefaction unit (not shown). Should drum gas discharge (208) have excessive entrained liquid then the drum gas discharge (208) can be routed for further liquid gas separation.

FIG. 2D shows another embodiment of the disclosure whereby a gas liquid solid phase separating device (212) placed upstream of the membrane filter (202) removing liquid and solid substances from gaseous mixture (201) before the gas liquid solid phase separating device gas discharge (201a) becomes in contact with the membrane filter (209) where the subsequent steps described in FIG. 2C are repeated.

FIG. 2E shows another embodiment of the disclosure where the gaseous mixture (201) comes into contact with the membrane filter (209). The membrane filter separates the gaseous mixture (201) into membrane filter retentave discharge (210) and membrane filter permeate discharge (211). The membrane retentive discharge (210) is then discharged into a pipeline (not shown), road or rail carriage (not shown), or small-scale liquefaction unit (not shown). To draw the gaseous mixture (201) through the membrane filter (209) at optimal pressure the membrane permeate (211) enters the ejector (202) where the same closed loop liquid motive circuit detailed in FIG. 2A involving a drum (204) and compression device (206) provides the compression device liquid motive discharge (207) used to drive the ejector (202). The drum gas discharge (208) which is separated from liquid within the gas liquid mixture ejector discharge (203) in the drum (204) may then be discharged for example and not limited a storage container (not shown), pipeline (not shown), road or rail carriage (not shown), combustion device (not shown) or other use.

FIG. 2F shows another embodiment of the disclosure whereby a gas liquid solid phase separating device (212) is located upstream of the membrane filter (209) to substantially remove liquid and solid substances from the gaseous mixture (201). The gas liquid solid phase separating device gas discharge (201a) becomes in contact with the membrane (209) where the subsequent steps detailed in FIG. 2E are repeated.

FIG. 3A shows another embodiment of the disclosure whereby a gaseous mixture (301) passes through an ejector (302) which increases pressure within the gas gas mixture ejector discharge (304) to the optimal pressure for the membrane filter (305). The ejector (302) is driven by a high pressure gas motive (303) which may be from another high pressure gas well or other source of pressurized gas. The relatively low pressure gaseous mixture (301) and the relatively high pressure gas motive (303) are mixed in the ejector (302) resulting in an intermediate pressure ejector discharge (304). The ejector discharge (304) then contacts the membrane filter (305) where the ejector discharge (304) is separated into membrane filter retentave discharge (306) and membrane filter permeate discharge (307). The membrane retentive discharge (306) is then discharged into a pipeline (not shown), road or rail carriage (not shown), or small-scale liquefaction unit (not shown). The membrane filter permeate discharge (307) may be discharged into a pipeline (not shown), storage container (not shown) or combustion device (not shown) or other use. Should a combustion device be used, the generated power and heat may be utilized to support associated field activities or sold back into the electrical grid. Should an increase in the calorific value of the membrane filter permeate discharge (307) be required to optimize combustion in the combustion device, then a percentage of the membrane filter retentave discharge (306) can be drawn off and mixed with the membrane filter permeate discharge (307) to increase the combined calorific value at the combustion device inlet and optimize combustion efficiency.

FIG. 3B shows another embodiment of the disclosure whereby gaseous mixture (301) passes through a gas liquid solid phase separating device (308) removing liquid and solid substances from the gaseous mixture (301). The gas liquid solid phase separating device discharge (301a) is then pressurized by the ejector (302) where the ejector discharge (304) then makes contact with the membrane filter (305). The subsequent steps detailed in FIG. 3A are then repeated.

FIG. 3C shows a another embodiment of the disclosure whereby the high pressure gas motive (303) passes through a high pressure gas liquid solid phase separating device (309) which substantially removes water and solids from the high pressure gas motive (303). The high pressure gas liquid solid phase separating device discharge (303a) then passes through the ejector (302) and the subsequent steps detailed in FIG. 3B are repeated.

FIG. 3D shows another embodiment of the disclosure where a gaseous mixture (301) passes through a membrane filter (305) where the gaseous mixture (301) is separated into membrane filter retentave discharge (306) and membrane filter permeate discharge (307). The membrane filter permeate discharge (307) may be discharged into a pipeline (not shown), storage container (not shown) or combustion device (not shown) or other use. The membrane filter retentave discharge (306) is drawn into the ejector (302) where the membrane filter retentave discharge (306) is mixed with high pressure gas motive (303) that may have already been processed to at least the same purity requirements as the membrane filter retentave discharge (306). The ejector discharge (304) is then discharged into a pipeline (not shown), road or rail carriage (not shown), or small-scale liquefaction unit (not shown).

FIG. 3E shows another embodiment of the disclosure whereby the gaseous mixture (301) passes through a gas liquid solid phase separating device (308) where liquids and solids are substantially removed from the gaseous mixture (301). The gas liquid solid phase separating device discharge (301a) then enters the membrane filter (305) where the subsequent steps detailed in FIG. 3D are repeated.

In another embodiment of the disclosure detailed in FIGS. 3D and 3E, an additional high pressure gas liquid solid phase separating device (309), not shown in the diagrams pertaining to this disclosure is installed within the high pressure gas motive (303) stream. The high pressure gas liquid solid phase separating device (309) removes liquid and solid phases before the high pressure motive (303) makes contact with the ejector (302). In another embodiment of the disclosure an additional high pressure gas membrane filter (not shown) is installed within the high pressure motive (303) stream before the high pressure motive (303) makes contact with the ejector (302). The high pressure gas membrane filter removes impurities from the high pressure motive (303) to meet the gas composition as the membrane filter retentave discharge (306).

It should be understood that the system shown in FIGS. 1A-1E, 2A-2F and 3A-3E may be implemented in various arrangements, with additional or reduced components.

I claim:

1. A method for increasing the purity content of a gaseous mixture comprising at least
a. A pressurized gaseous mixture comprising a pure gaseous component and at least one additional impure gaseous component of suitable pressure;
b. A means of conveying said pressurized gaseous mixture into contact with a membrane filter where it is separated to form both a second retentave gaseous mixture relatively rich in said pure gaseous component and relatively lean in said additional impure component and a third permeate gaseous mixture relatively lean in said pure gaseous component and relatively rich in said additional impure gaseous component;
c. A second means of conveying said second retentave gaseous component into contact with a pipeline;
d. A third means of conveying said third permeate gaseous component into contact with a combustion device creating power and heat.

2. The method of claim 1 further including a gas rotational compression device to generate or increase pressure within said pressurized gaseous mixture located upstream or downstream from said membrane filter.

3. The method of claim 1 further including a liquid-motive ejector device increases pressure within said pressurized gaseous mixture located upstream or downstream from said membrane filter.

4. The method of claim 1 further including a gas-motive ejector device increases pressure within said pressurized gaseous mixture located upstream or downstream from said membrane filter.

5. The method of claim 1 wherein a gas liquid solid phase separating device substantially separating said gas mixture from liquid and solid impurities upstream from said membrane filter.

8. A method for increasing the purity content of a gaseous mixture comprising at least
a. A pressurized gaseous mixture comprising a pure gaseous component and at least one additional impure gaseous component of suitable pressure;
b. A means of conveying said pressurized gaseous mixture into contact with a membrane filter where it is separated to form both a second retentave gaseous mixture relatively rich in said pure gaseous component and relatively lean in said additional impure component and a third permeate gaseous mixture relatively lean in said pure gaseous component and relatively rich in said additional impure gaseous component;
c. A second means of conveying said second retentave gaseous component into contact with a pressurized road or rail carriage device.

9. The method of claim 8 further including a gas rotational compression device to generate or increase pressure within said pressurized gaseous mixture located upstream or downstream from said membrane filter.

10. The method of claim 8 further including a liquid-motive ejector device increases pressure within said pressurized gaseous mixture located upstream or downstream from said membrane filter.

11. The method of claim 8 further including a gas-motive ejector device increases pressure within said pressurized gaseous mixture located upstream or downstream from said membrane filter.

12. The method of claim 8 wherein a gas liquid solid phase separating device substantially separating said gas mixture from liquid and solid impurities upstream from said membrane filter.

13. The method of claim 8 further including a means of conveying said third permeate gaseous component into contact with a combustion device creating power and heat.

14. A method for increasing the purity content of a gaseous mixture comprising at least
a. A pressurized gaseous mixture comprising a pure gaseous component and at least one additional impure gaseous component of suitable pressure;
b. A means of conveying said pressurized gaseous mixture into contact with a membrane filter where it is separated to form both a second retentave gaseous mixture relatively rich in said pure gaseous component and relatively lean in said additional impure component and a third permeate gaseous mixture relatively lean in said pure gaseous component and relatively rich in said additional impure gaseous component;
c. A means of conveying said second retentive gaseous component into contact with a small-scale liquefaction unit where the second gaseous mixture is cooled to a suitable condensation temperature to create a gas liquid phase change.

15. The method of claim 14 further including a gas rotational compression device to generate or increase pressure within said pressurized gaseous mixture located upstream or downstream from said membrane filter.

16. The method of claim 14 further including a liquid-motive ejector device increases pressure within said pressurized gaseous mixture located upstream or downstream from said membrane filter.

17. The method of claim 14 further including a gas-motive ejector device increases pressure within said pressurized gaseous mixture located upstream or downstream from said membrane filter.

18. The method of claim 14 wherein a gas liquid solid phase separating device substantially separating said gas mixture from liquid and solid impurities upstream from said membrane filter.

19. The method of claim 14 further including a means of conveying said third permeate gaseous component into contact with a combustion device creating power and heat.
